(19) United States
(12) Patent Application Publication
(10) Pub. No.: US 2026/0017208 A1
(43) Pub. Date: Jan. 15, 2026

(54) KEY-VALUE CACHE MANAGEMENT, MODEL REASONING, AND DATA PROCESSING METHODS AND APPARATUSES FOR LARGE LANGUAGE MODELS

(71) Applicant: Alipay (Hangzhou) Information Technology Co., Ltd., Hangzhou (CN)

(72) Inventors: Rui Zhang, Hangzhou (CN); Junping Zhao, Hangzhou (CN)

(73) Assignee: Alipay (Hangzhou) Information Technology Co., Ltd., Hangzhou (CN)

(21) Appl. No.: 18/958,887

(22) Filed: Nov. 25, 2024

(30) Foreign Application Priority Data
Jul. 9, 2024 (CN) 202410915392.8

(51) Int. Cl. G06F 12/1045

(52) U.S. Cl. CPC G06F 12/1063; G06F 2212/657

(57) ABSTRACT

Implementations of this specification provide key-value cache management, model reasoning, and data processing methods and apparatuses for large language models. In an implementation, a method comprises allocating a virtual memory block in a virtual address slot to newly-added token key-value data of a model reasoning request, in response to determining that a scheduling result of the model reasoning request indicates the model reasoning request is scheduled for execution, maintaining a mapping relationship between an occupied virtual address slot and a physical graphics memory block allocated to the model reasoning request, and copying the newly-added token key-value data to the physical graphics memory block.

### CROSS-REFERENCE TO RELATED APPLICATIONS

This application claims priority to Chinese Patent Application No. 202410915392.8, filed on Jul. 9, 2024, which is hereby incorporated by reference in its entirety.

### TECHNICAL FIELD

Embodiments of this specification generally relate to the field of data processing technologies, and in particular, to key-value cache (KV Cache) management, model reasoning, and data processing methods and apparatuses for large language models.

### BACKGROUND

With continuous development of science and technology, a large language model has become a hotspot in the field of artificial intelligence. The large language model is an artificial intelligence technology based on deep learning. A core of the large language model is to train the large language model based on a large-scale data set, so that the large language model can understand and generate a natural language text.

The large language model can be, for example, a neural network architecture with an attention module, for example, a large language model based on a transformer. The neural network architecture is implemented as an encoder-decoder architecture, an encoder and a decoder each are formed by stacking a plurality of same layers, and each layer includes an attention sublayer (for example, a self-attention sublayer) and a feedforward neural network sublayer. When large language model reasoning is performed, the attention sublayer is used to capture a dependency relationship between tokens in a current input sequence, and introduce the captured dependency relationship into a generation process of a to-be-input token.

In a forward reasoning process of each layer of model of the large language model, attention needs to be computed. During attention computing, attention between a current token and all previously generated tokens needs to be performed, so that key (K) vectors and value (V) vectors of all tokens need to be repeatedly computed. Due to a large model width and a large quantity of layers of the large language model, a computing time of attention computing is relatively long. Especially, when a sequence length of a request (prompt) input by a user is relatively long, a computing time of attention computing accounts for a more prominent ratio.

A KV cache is a commonly used attention computing acceleration method. During attention computing, a key-value (KV) pair of a previously generated token can be stored, to form the KV cache. In such a manner, when attention computing is performed based on a sequence to which a new token is added, a KV pair of the previously generated token can be obtained from the KV cache, to avoid performing redundancy computing on the KV pair of the previously generated token, thereby accelerating attention computing. However, the KV cache occupies a large amount of GPU memory, so that management efficiency of the KV cache exerts important impact on model reasoning performance of the large language model.

### SUMMARY

Embodiments of this specification provides KV cache management, model reasoning, and data processing methods and apparatuses for large language models. In the KV cache management solution, a virtual address space needed by a KV cache is equally divided based on a maximum amount of batch request processing of the large language model, to obtain a plurality of virtual address slots, and a maximum actually available physical graphics memory capacity of model reasoning is equally divided based on a specified capacity size, to obtain a plurality of physical graphics memory blocks. After a virtual memory block in the virtual address slot is allocated to newly-added token key-value data of a to-be-processed model reasoning request, and it is determined, based on the allocated virtual memory block and a capacity size of a currently available physical graphics memory block, that the model reasoning request is scheduled for execution, a mapping relationship between an allocated physical graphics memory block and an occupied virtual address slot is maintained, and slot indication information of the occupied virtual address slot is stored in a valid virtual address slot table. Then, the newly-added token key-value data of the model reasoning request are copied to the physical graphics memory block allocated to the model reasoning request. In the key-value cache management solution, because a mapping relationship is established only between the physical graphics memory block and a virtual address slot occupied by the model reasoning request, after a mapped physical graphics memory block is found based on the slot indication information of the virtual address slot, all stored sequence token key-value data can be sequentially retrieved without a need to consider mapping between virtual memory blocks occupied by all tokens in the virtual address slot, so that a mapping process is simpler, KV cache management complexity is reduced, and KV cache management efficiency is further improved.

According to one aspect of the embodiments of this specification, a key-value cache management method for large language model reasoning is provided, including: allocating a virtual memory block in a virtual address slot to newly-added token key-value data of a to-be-processed model reasoning request, where the virtual address slot is formed by equally dividing a virtual address space needed by a key-value cache, and a quantity of virtual address slots is equal to a maximum amount of batch request processing of a large language model; maintaining a mapping relationship between an occupied virtual address slot and a physical graphics memory block allocated to the to-be-processed model reasoning request, in response to that a scheduling result of the to-be-processed model reasoning request indicates that the to-be-processed model reasoning request is scheduled for execution, where the physical graphics memory block is formed by equally dividing a maximum actually available physical graphics memory capacity of model reasoning; and copying the newly-added token key-value data to the allocated physical graphics memory block, where the scheduling result is determined based on the allocated virtual memory block and a capacity size of a currently available physical graphics memory block, each to-be-processed model reasoning request occupies one virtual address slot, and slot indication information of the occupied virtual address slot is recorded in a valid virtual address slot table.

Optionally, in an example of the above-mentioned aspect, before the allocating a virtual memory block in a virtual address slot to newly-added token key-value data of a to-be-processed model reasoning request, the key-value cache management method further includes: for a model reasoning request of completed model reasoning processing after a previous model reasoning process, releasing an occupied virtual address slot, removing the mapping relationship between the allocated physical graphics memory block and the occupied virtual address slot, and deleting the slot indication information of the occupied virtual address slot from the valid virtual address slot table.

Optionally, in an example of the above-mentioned aspect, the to-be-processed model reasoning request includes a new model reasoning request and a model reasoning request of uncompleted model reasoning processing after the previous model reasoning process, and scheduling processing of the model reasoning request of uncompleted model reasoning processing is completed before scheduling processing of the new model reasoning request.

Optionally, in an example of the above-mentioned aspect, the maintaining a mapping relationship between an occupied virtual address slot and a physical graphics memory block allocated to the to-be-processed model reasoning request, when a scheduling result indicates that the to-be-processed model reasoning request is scheduled for execution includes: for a model reasoning request of uncompleted model reasoning processing, when a remaining graphics memory capacity of a currently mapped physical graphics memory block is sufficient to store the newly-added token key-value data, maintaining the mapping relationship of the physical graphics memory block unchanged, and updating an actual use capacity of the physical graphics memory block; or when a remaining graphics memory capacity of a currently mapped physical graphics memory block is insufficient to store the newly-added token key-value data, additionally mapping a sufficient quantity of physical graphics memory blocks in idle physical graphics memory blocks to the occupied virtual address slot, and updating an actual mapping quantity and an actual use capacity of physical graphics memory blocks.

Optionally, in an example of the above-mentioned aspect, the maintaining a mapping relationship between an occupied virtual address slot and a physical graphics memory block allocated to the to-be-processed model reasoning request, when a scheduling result indicates that the to-be-processed model reasoning request is scheduled for execution includes: for a new model reasoning request, mapping a sufficient quantity of physical graphics memory blocks in idle physical graphics memory blocks to the occupied virtual address slot, and updating an actual mapping quantity and an actual use capacity of the physical graphics memory block.

Optionally, in an example of the above-mentioned aspect, the virtual address space is determined based on a maximum quantity of batch processing requests of the large language model, a maximum sequence length, a quantity of hidden layers of the large language model, and a data type size of stored data.

According to another aspect of the embodiments of this specification, a method for large language model reasoning is provided, including: in response to that performing of model reasoning is started, determining a physical graphics memory block corresponding to performed model reasoning based on slot indication information of a virtual address slot in a valid virtual address slot table; sequentially retrieving all stored sequence token key-value data from the determined physical graphics memory block; and performing model reasoning based on the sequence token key-value data.

According to another aspect of the embodiments of this specification, a data processing method for large language model reasoning is provided, including: allocating a virtual memory block in a virtual address slot to newly-added token key-value data of a to-be-processed model reasoning request, where the virtual address slot is formed by equally dividing a virtual address space needed by a key-value cache, and a quantity of virtual address slots is equal to a maximum amount of batch request processing of a large language model; determining, based on the allocated virtual memory block and a physical graphics memory capacity of a currently available physical graphics memory block, whether the to-be-processed model reasoning request is scheduled for execution, where the physical graphics memory block is formed by equally dividing a maximum actually available physical graphics memory capacity of model reasoning, each to-be-processed model reasoning request occupies one virtual address slot, and slot indication information of the occupied virtual address slot is recorded in a valid virtual address slot table; maintaining a mapping relationship between the occupied virtual address slot and a physical graphics memory block allocated to the to-be-processed model reasoning request, in response to that the to-be-processed model reasoning request is scheduled for execution; copying the newly-added token key-value data to the allocated physical graphics memory block; in response to that performing of model reasoning is started, determining the physical graphics memory block corresponding to the to-be-processed model reasoning request based on slot indication information of the virtual address slot in the valid virtual address slot table, and sequentially retrieving all stored sequence token key-value data from the determined physical graphics memory block; and performing model reasoning based on the sequence token key-value data.

According to another aspect of the embodiments of this specification, a key-value cache management apparatus for large language model reasoning is provided, including: a virtual memory block allocation unit, configured to allocate a virtual memory block in a virtual address slot to newly-added token key-value data of a to-be-processed model reasoning request, where the virtual address slot is obtained by equally dividing a virtual address space needed by a key-value cache, and a quantity of virtual address slots is equal to a maximum amount of batch request processing of a large language model; a mapping relationship maintenance unit, configured to maintain a mapping relationship between an occupied virtual address slot and a physical graphics memory block allocated to the to-be-processed model reasoning request, in response to that a scheduling result of the to-be-processed model reasoning request indicates that the to-be-processed model reasoning request is scheduled for execution, where the physical graphics memory block is obtained by equally dividing a maximum actually available physical graphics memory capacity of model reasoning; and a data copying unit, configured to copy the newly-added token key-value data to the allocated physical graphics memory block, where the scheduling result is determined based on the allocated virtual memory block and a capacity size of a currently available physical graphics memory block, each to-be-processed model reasoning request occupies one virtual address slot, and slot indication information of the occupied virtual address slot is recorded in a valid virtual address slot table.

According to another aspect of the embodiments of this specification, a model reasoning apparatus for large language model reasoning is provided, including: a physical graphics memory block determining unit, configured to: in response to that performing of model reasoning is started, determine a physical graphics memory block corresponding to performed model reasoning based on slot indication information of a virtual address slot in a valid virtual address slot table; a data retrieval unit, configured to sequentially retrieve all stored sequence token key-value data, from the determined physical graphics memory block; and a model reasoning unit, configured to perform model reasoning based on the sequence token key-value data.

According to another aspect of the embodiments of this specification, a data processing system for large language model reasoning is provided, including: the above-mentioned key-value cache management apparatus; a scheduling apparatus, configured to determine, based on an allocated virtual memory block and a capacity size of a currently available physical graphics memory block, whether the to-be-processed model reasoning request is scheduled for execution, where the physical graphics memory block is formed by equally dividing a maximum actually available physical graphics memory capacity of model reasoning, each to-be-processed model reasoning request occupies one virtual address slot, and slot indication information of the occupied virtual address slot is recorded in a valid virtual address slot table; and the above-mentioned model reasoning apparatus.

According to another aspect of the embodiments of this specification, a key-value cache management apparatus for large language model reasoning is provided, including: at least one processor; a storage coupled to the at least one processor; and a computer program stored in the storage. The at least one processor executes the computer program to implement the above-mentioned key-value cache management method for large language model reasoning.

According to another aspect of the embodiments of this specification, an apparatus for large language model reasoning is provided, including: at least one processor; a storage coupled to the at least one processor; and a computer program stored in the storage. The at least one processor executes the computer program to implement the above-mentioned method for large language model reasoning.

According to another aspect of the embodiments of this specification, a data processing apparatus for large language model reasoning is provided, including: at least one processor; a storage coupled to the at least one processor; and a computer program stored in the storage. The at least one processor executes the computer program to implement the above-mentioned data processing method for large language model reasoning.

According to another aspect of some embodiments of this specification, a computer-readable storage medium is provided. The computer-readable storage medium stores executable instructions, and when the instructions are executed, a processor is enabled to perform the above-mentioned key-value cache management method for large language model reasoning, or perform the above-mentioned method for large language model reasoning, or perform the above-mentioned data processing method for large language model reasoning.

According to another aspect of the embodiments of this specification, a computer program product is provided, including a computer program. The computer program is executed by a processor, to implement the above-mentioned key-value cache management method for large language model reasoning, or implement the above-mentioned method for large language model reasoning, or implement the above-mentioned data processing method for large language model reasoning.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 is an example flowchart illustrating a forward reasoning process of a model;

FIG. 2 is an example schematic diagram illustrating a KV cache management solution based on sequence length concatenation;

FIG. 3 is an example schematic diagram illustrating a KV cache management solution based on maximum sequence length allocation;

FIG. 4 is an example schematic diagram illustrating a KV cache management solution based on a customized reasoning engine;

FIG. 5 is a schematic diagram illustrating an example framework of a customized reasoning engine vLLM;

FIG. 6 is an example schematic diagram illustrating a block table;

FIGS. 7A, 7B, and 7C are example schematic diagrams illustrating a paged management solution of a KV cache;

FIG. 8 is an example flowchart illustrating a data processing method for model reasoning of a large language model, according to one or more embodiments of this specification;

FIG. 9 is an example schematic diagram illustrating a virtual address space needed by a KV cache, according to one or more embodiments of this specification;

FIG. 10 is an example schematic diagram illustrating a valid virtual address slot table, according to one or more embodiments of this specification;

FIG. 11 is a schematic diagram illustrating an example of a KV cache after allocation of a physical graphics memory block is completed and mapping is established, according to one or more embodiments of this specification;

FIG. 12 is an example schematic diagram illustrating a KV cache management solution for a completed model reasoning request, according to one or more embodiments of this specification;

FIG. 13 is an example block diagram illustrating a data processing system for large language model reasoning, according to one or more embodiments of this specification;

FIG. 14 is an example block diagram illustrating a key-value cache management apparatus for large language model reasoning, according to one or more embodiments of this specification;

FIG. 15 is an example block diagram illustrating a model reasoning apparatus for large language model reasoning, according to one or more embodiments of this specification;

FIG. 16 is an example schematic diagram illustrating a key-value cache management apparatus for large language model reasoning that is implemented based on a computer system, according to one or more embodiments of this specification;

FIG. 17 is an example schematic diagram illustrating a model reasoning apparatus for large language model reasoning that is implemented based on a computer system, according to one or more embodiments of this specification; and

FIG. 18 is an example schematic diagram illustrating a data processing system for large language model reasoning that is implemented based on a computer system, according to one or more embodiments of this specification.

### DESCRIPTION OF EMBODIMENTS

The subject matters described in this specification are discussed below with reference to example implementations. It should be understood that the discussion of these implementations is merely intended to enable a person skilled in the art to better understand the subject matters described in this specification, and is not intended to limit the protection scope, applicability, or examples described in the claims. The functions and arrangements of the elements under discussion can be changed without departing from the protection scope of this specification. Various processes or components can be omitted, replaced, or added in various examples as needed. For example, the described method can be performed in a sequence different from the described sequence, and the steps can be added, omitted, or combined. In addition, the features described in some examples can also be combined in other examples.

As used in this specification, the term “include” and variants thereof represent an open term, which means “including but not limited to”. The term “based on” represents “at least partially based on”. The terms “one embodiment” and “an embodiment” denote “at least one embodiment”. The term “another embodiment” means “at least one other embodiment”. The terms “first”, “second”, etc. can refer to different or identical objects. Other definitions, whether explicit or implicit, can be included below. Unless expressly specified in the context, the definition of a term is consistent throughout this specification.

A flowchart used in this specification illustrates operations implemented by a system according to some embodiments of this specification. It should be clearly understood that operations in the flowchart can be implemented out of sequence. In contrast, the operations can be implemented in reverse order or simultaneously. In addition, one or more other operations can be added to the flowchart. One or more operations can be removed from the flowchart.

A well-trained large language model is deployed in a reasoning framework such as a GPU device, and model reasoning is performed based on a request (prompt) input by a user, to generate and return a proper statement. Model reasoning of the large language model includes forward reasoning processes (also referred to as decoding processes) of a plurality of layers of models. A forward reasoning process of each layer of model is used to predict and generate a new token based on a current input sequence. The predicted and generated new token is added to the current input sequence, and is used as a current input sequence of a next decoding process. This is cyclically performed, until a final result is inferred. It is worthwhile to note that in this specification, the term “sequence” is used to refer to a model input of each forward reasoning process. In the first forward reasoning process, the sequence includes a prompt input by the user. Subsequently, after the first forward reasoning process, a corresponding output output1 is obtained. In the second forward reasoning process, the sequence includes a request prompt input by the user and the output output1 obtained after the first forward reasoning process. Subsequently, after the second forward reasoning process, a corresponding output output2 is obtained. This is cyclically performed, until a final output sequence is obtained.

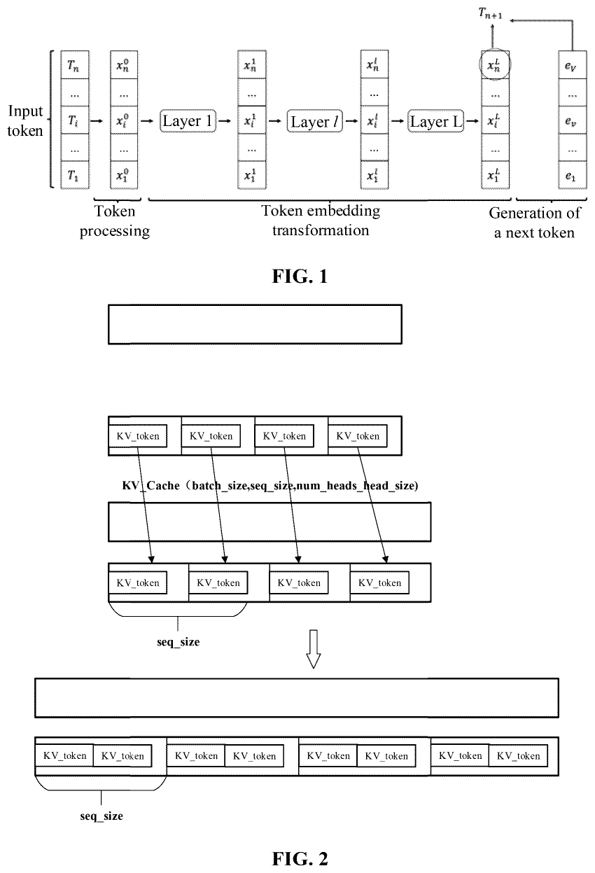

FIG. 1 is an example flowchart illustrating a forward reasoning process of a model.

As shown in FIG. 1, n tokens {T₁, T₂, . . . , Tₙ} in a current input sequence pass through an embedding layer, and then token embedding vectors

$$\{ {x}_{i}^{0} , {x}_{i}^{1} , … , {x}_{i}^{n} \}$$

are obtained. Then, L layers of forward transformation (model reasoning) are performed based on the token embedding vectors

$$\{ {x}_{i}^{0} , {x}_{i}^{1} , … , {x}_{i}^{n} \} ,$$

to obtain

$$\{ {x}_{i}^{L} , {x}_{i}^{L} , … , {x}_{i}^{L} \}$$

Then, the last token embedding vector xᵢ^{L} in the last layer of token embedding vectors

$$\{ {x}_{i}^{L} , {x}_{i}^{L} , … , {x}_{i}^{L} \}$$

is retrieved, and is computed with token embedding vectors {e₁, e₂, . . . , eᵥ} of an lm_head layer of a large language model, to obtain probabilities {p₁, p₂, . . . , pᵥ}, and then a newly generated token Tₙ₊₁ is selected based on the probabilities {p₁, p₂, . . . , pᵥ}.

In a forward reasoning process of each layer of model of the large language model, attention needs to be computed. During attention computing, attention between a current token and all previously generated tokens needs to be performed, so that key (K) vectors and value (V) vectors of all tokens need to be repeatedly computed. Due to a large model width and a large quantity of layers of the large language model, a computing time of attention computing is relatively long.

A KV cache is a commonly used attention computing acceleration method. During attention computing, a KV pair of a previously generated token can be stored, to form the KV cache. In such a manner, when attention computing is performed based on a sequence to which a new token is added, a KV pair of the previously generated token can be obtained from the KV cache, to avoid performing redundancy computing on the key-value (KV) pair of the previously generated token, thereby accelerating attention computing. However, the KV cache occupies a large amount of GPU memory, and management efficiency of the KV cache exerts important impact on model reasoning performance of the large language model.

Current KV cache management solutions include a KV cache management solution based on a general reasoning engine and a KV cache management solution based on a customized reasoning engine. An input parameter shape of an attention kernel of the general reasoning engine is (batch_size, seq_len, num_heads, head_size). Here, batch_size represents a batch processing size, namely, a quantity of sequences processed in a batch, seq_len represents a sequence length, num_heads represents a quantity of attention heads, and head_size represents an attention head size. A tensor management manner is used in the KV cache management solution based on the general reasoning engine, and the KV cache management solution based on the general reasoning engine mainly includes a KV cache management solution based on sequence length concatenation and a KV cache management solution based on maximum sequence length allocation.

FIG. 2 is an example schematic diagram illustrating a KV cache management solution based on sequence length concatenation.

As shown in FIG. 2, in the KV cache management solution based on sequence length concatenation, KV caches are allocated to all sequences, and are sequentially stored in an overall tensor. After a new KV token is generated for a sequence, the newly generated KV token is concatenated to a previous KV token sequence of the sequence based on a seq_len dimension, to obtain a new KV token sequence. Subsequently, a KV cache allocated to the previous KV token sequence is released from the tensor, a new KV cache is allocated to the new KV token sequence, and the new KV token sequence is stored on the allocated new KV cache.

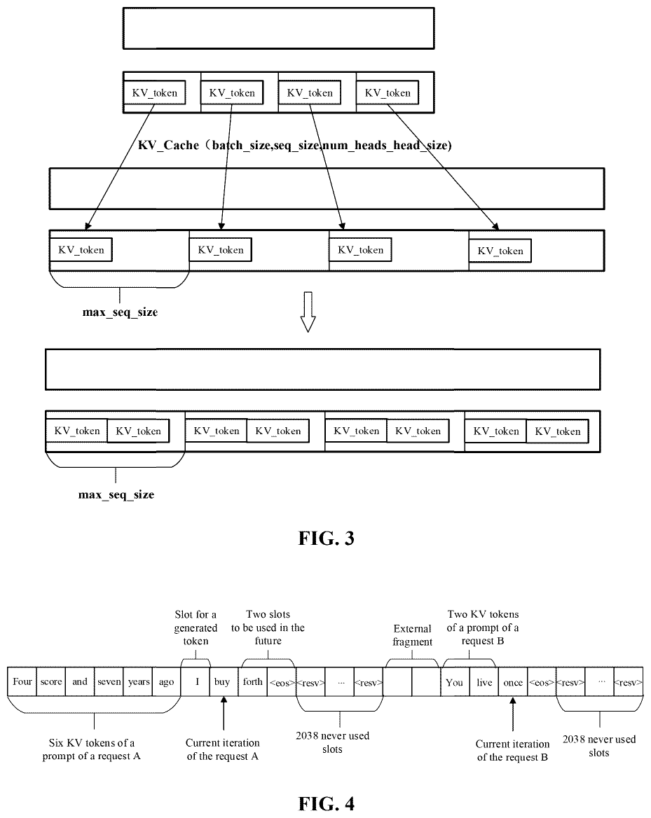

FIG. 3 is an example schematic diagram illustrating a KV cache management solution based on maximum sequence length allocation.

As shown in FIG. 3, in the KV cache management solution based on maximum sequence length allocation, KV caches are allocated to all sequences based on max_seq, and are sequentially stored in an overall tensor. After a new KV token is generated for a sequence, the newly generated KV token is copied to the KV cache of the corresponding sequence.

According to the above-mentioned two KV cache management solutions, computing efficiency of attention computing can be improved based on a general attention kernel. However, the above-mentioned KV cache management solution is a sequence-granularity KV cache management solution, and does not support a fine-granularity KV cache management manner (for example, token-granularity paged attention). In addition, many graphics memory spaces are wasted if the KV caches are allocated based on max_seq. If concatenation is performed based on the seq_len dimension, there are overheads of frequently allocating and releasing graphics memory, and there are overheads of repeatedly copying the previously generated token. In addition, if continuous batch processing (continuous batch) needs to be supported, a reasoning framework needs to be modified to a relatively large extent. For example, the attention kernel and a scheduler are jointly modified, and there are overheads of allocating, copying, and releasing graphics memory. The term “continuous batch” can refer to a batch operation. If a model reasoning request is processed, a new model reasoning request can be added to a currently uncompleted batch to perform model reasoning processing together.

Different from the general reasoning engine, an input parameter shape of an attention kernel of the customized reasoning engine is (num_blocks, num_heads, head_size, block_size). Here, num_blocks represents a quantity of blocks, num_heads represents a quantity of attention heads, head_size represents an attention head size, and block_size represents a block size.

FIG. 4 is an example schematic diagram illustrating a KV cache management solution based on a customized reasoning engine.

As shown in FIG. 4, for a batch, an enormous tensor is applied for. Then, KV tokens of all sequences in the batch are placed at different locations in the tensor in a fine-granularity paged manner. According to the above-mentioned KV cache management solution, graphics memory fragments can be reduced, and batch_size can be improved, to improve throughput performance. In addition, according to the solution, a function of the continuous batch can be conveniently integrated, without a need to copy, allocate, and release graphics memory.

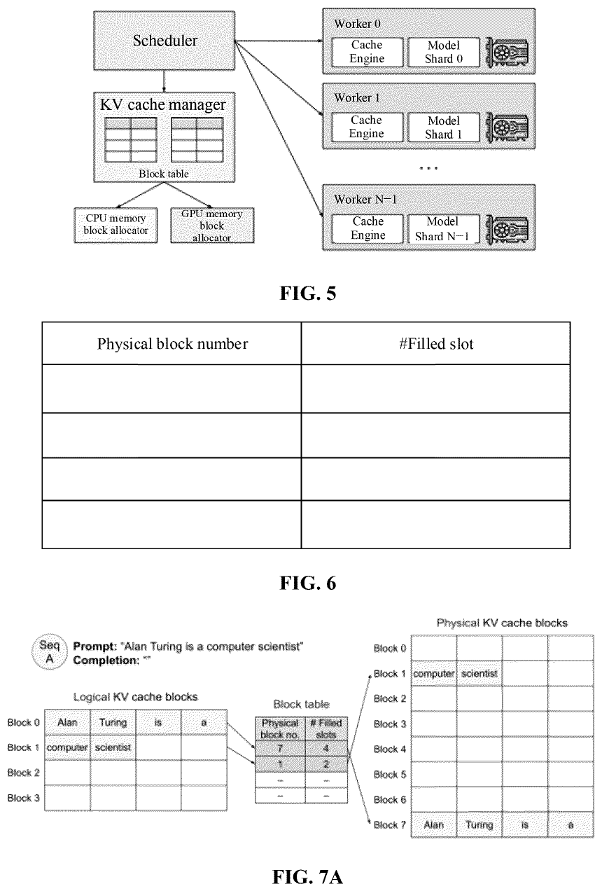

FIG. 5 is a schematic diagram illustrating an example framework of a customized reasoning engine vLLM.

As shown in FIG. 5, a system architecture of the vLLM includes a scheduler, a KV cache manager, a CPU memory block allocator/GPU memory block allocator, and a worker node (Worker). The scheduler is responsible for scheduling a sequence request transmitted to the vLLM. The KV cache manager is responsible for managing occupation of the KV cache block by the sequence request. The CPU memory block allocator and the GPU memory block allocator represent a CPU memory block and a GPU memory block that are actually allocated. The worker is responsible for actually executing a model reasoning process of the large language model.

The vLLM manages the KV cache in a paged management manner. When a model reasoning framework is started, a maximum amount of graphics memory available to the KV cache is analyzed, and then a corresponding quantity of tensors are allocated based on a shape of a key and a value and a quantity of model layers, to store a KV token. The scheduler determines, based on an actual quantity of requests, a proper location at which a KV token in a currently input prompt and a generated KV token (for example, generated by a decoder) are placed in a KV cache tensor.

For ease of management, two block types are implemented in the vLLM, one is a logical block (logical block/virtual graphics memory block), and the other is a physical block (physical graphics memory block). The KV cache of each sequence is divided into physical blocks with fixed sizes, and each physical block stores KV pairs of several tokens in the sequence. In addition, a data structure referred to as a block table is used to reflect a logical-physical KV block mapping solution. The block table is used to record a specific physical block in which a KV of each sequence is distributed. According to the above-mentioned solution, continuous KV pairs can be allowed to be discontinuously distributed in the physical block.

FIG. 6 is an example schematic diagram illustrating a block table. In FIG. 6, a physical block number represents a physical block number, and a filled slot represents an offset of a stored KV token in the physical block.

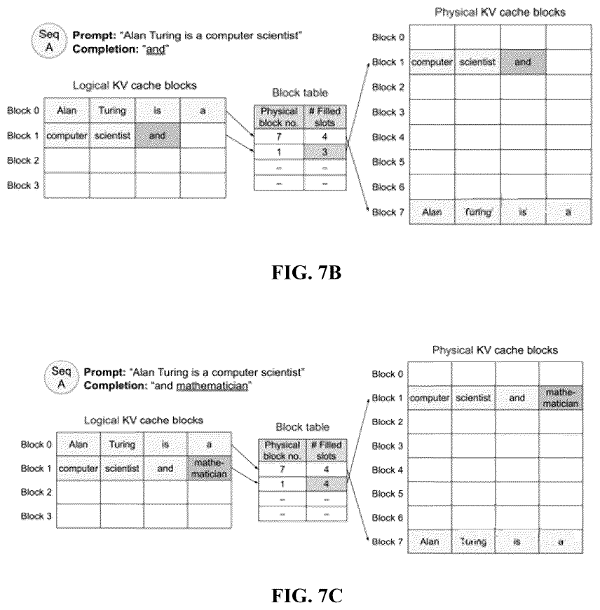

The following describes a paged management solution of the KV cache with reference to FIG. 7A to FIG. 7C.

When a new request “Alan Turning is a computer scientist” arrives, the new request is first filled in the logical block for virtual occupation. Subsequently, the scheduler generates a proper logical-physical block mapping solution based on a logical KV block and a current remaining physical KV block, as shown in FIG. 7A.

When attention computing is performed based on “Alan Turning is a computer scientist”, a corresponding physical block number is obtained based on the block table, and then an offset of each token in each seq is computed based on the slot, to retrieve the KV stored in the physical block for attention computing.

After the first token “and” is generated based on “Alan Turning is a computer scientist”, the generated token “and” is stored in the physical block, and a corresponding block table is generated, as shown in FIG. 7B.

Subsequently, after the second token “mathematician” is generated based on “Alan Turning is a computer scientist and”, the generated token “mathematician” is stored in the physical block, and a corresponding block table is generated, as shown in FIG. 7C. This is cyclically performed, until the last token is generated, to obtain a final model reasoning result.

Each time forward reasoning is performed, all pending sequences are traversed, and whether all pending sequences in the batch can be placed in a current remaining physical block is determined. If all the pending sequence in the batch cannot be placed currently, preemption occurs. A block table occupied by all sequences that can be scheduled to be executed is filled in a meta_data structure, and then the forward reasoning process of the model is executed. When an attention operation is performed, an attention operation in xformer is directly performed in a prefill phase; and a paged attention operation is performed in a decode phase. In the paged attention operation, a shape corresponding to the paged attention operation is (num_blocks, num_heads, head_size, block_size). During computing, a block table corresponding to each sequence is obtained, and all KV cache tokens corresponding to the sequence can be found. After forward reasoning of the model is completed, whether a sequence satisfying an end condition exists in all current batches is determined. If a sequence satisfying the end condition exists in all current batches, an output is returned, a block corresponding to the sequence is deleted, and the block occupied by the sequence is released. During next scheduling, another pending sequence can be added to the batch.

When the above-mentioned KV cache management solution is applied to an attention kernel with another function, a relatively large change needs to be made to the attention kernel.

In view of the above-mentioned descriptions, one or more embodiments of this specification provide a KV cache management solution. In the KV cache management solution, the fine-granularity KV cache management manner is implemented without changing a general attention kernel shape, so that the KV cache management solution can be conveniently and rapidly integrated in a general reasoning framework.

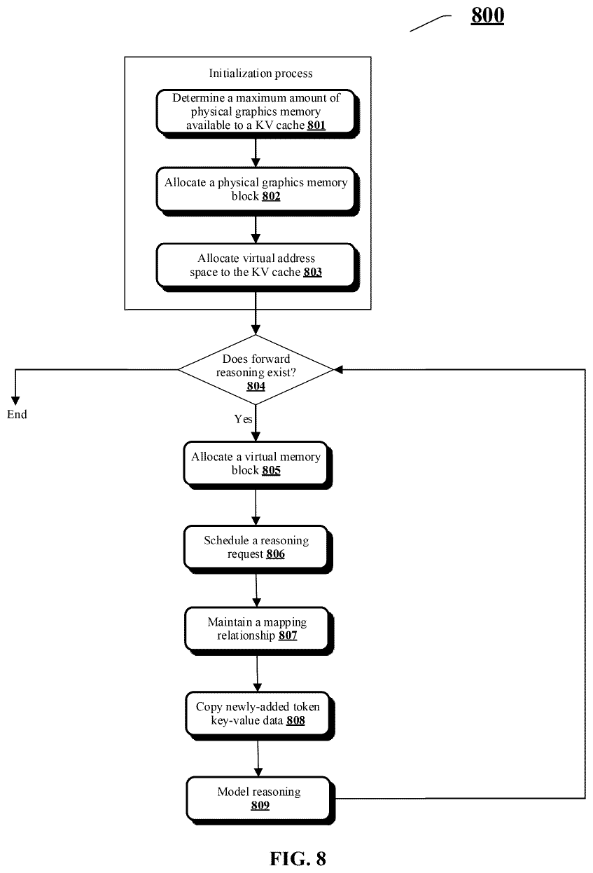

FIG. 8 is an example flowchart illustrating a data processing method 800 for model reasoning of a large language model, according to one or more embodiments of this specification.

As shown in FIG. 8, before model reasoning of the large language model needs to be performed, an initialization process needs to be performed. Specifically, during initialization, in 801, a KV cache management apparatus determines a maximum amount of physical graphics memory available to a KV cache. For example, the KV cache management apparatus can run one model reasoning process after the large language model works, thereby determining an amount of physical graphics memory needed for maintaining running of a model framework of the large language model, and removing, from provided physical graphics memory (for example, GPU memory of a GPU device), an amount of physical graphics memory needed for maintaining a model weight, an intermediate activation value, and the model framework, to obtain the maximum amount of physical graphics memory available to the KV cache.

Subsequently, in 802, the KV cache management apparatus invokes a virtual memory management apparatus (VMM apparatus) to allocate a plurality of physical graphics memory blocks (physical handles) at a granularity of a specified capacity size (for example, 2 MB), a total capacity size of the plurality of physical handles is equal to the maximum amount of physical graphics memory, and the plurality of physical handles are placed in a physical graphics memory pool for use in a single batch model reasoning process (single batch). Then, in 803, the KV cache management apparatus invokes the VMM apparatus to allocate, based on a configuration of the model reasoning framework, a virtual address space needed by the KV cache. For example, the virtual address space needed by the KV cache can be allocated based on max_batch_size*max_seq_len*hidden_size*datatype_size. Here, max_batch_size represents a maximum quantity of model reasoning requests of batch processing, max_seq_len represents a maximum sequence length of model reasoning requests that can be processed, hidden_size represents a quantity of hidden layers of the large language model, and datatype_size represents a data type size of stored data.

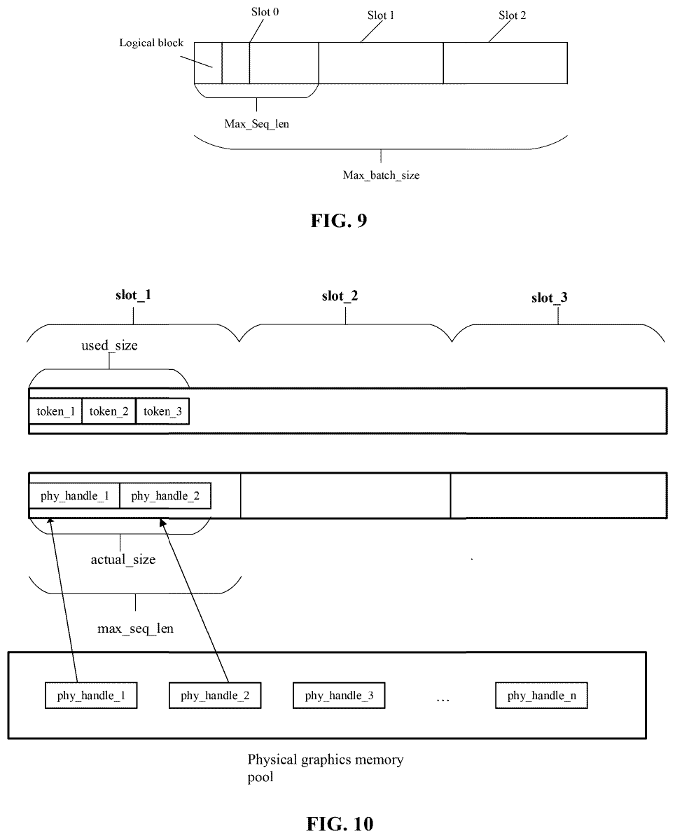

FIG. 9 is an example schematic diagram illustrating a virtual address space needed by a KV cache, according to one or more embodiments of this specification.

As shown in FIG. 9, the virtual address space can be divided into a plurality of virtual address slots (slot) of the same size. The virtual address slot can be formed, for example, by equally dividing a virtual address space needed by a key-value cache. A virtual address size of each slot is max_seq_len*size of virtual memory size occupied by a single token, and the virtual memory occupied by the single token is also referred to as a logical block or a virtual memory block. A quantity of slots obtained through division is equal to a maximum amount of batch request processing of the large language model, and each slot is occupied by one model reasoning request.

After initialization is completed as described above, model reasoning and KV cache management can be performed. Model reasoning can include a plurality of forward reasoning processes that are cyclically executed. Each time forward reasoning is performed, a scheduling apparatus needs to schedule a to-be-processed model reasoning request to a batch execution model to perform reasoning, for example, to perform an attention operation. Here, the to-be-processed model reasoning request can be referred to as a model reasoning request in a pending state. In some embodiments, the to-be-processed model reasoning request can include a new model reasoning request and/or a model reasoning request of uncompleted model reasoning processing after a previous model reasoning process. Before model reasoning is performed, a KV cache of the to-be-processed model reasoning request needs to be dynamically managed.

Back to FIG. 8, after initialization is completed, in 804, whether a forward reasoning process exists. If no forward reasoning process exists, a procedure ends. If a forward reasoning process exists, in 805, a virtual memory block a virtual address slot is allocated to newly-added token key-value data of the to-be-processed model reasoning request.

For a new model reasoning request, the KV cache management apparatus invokes a virtual memory manager to allocate a virtual memory block (for example, a logical block) for occupation based on token sizes of all tokens in a prompt of the new model reasoning request. For a model reasoning request of uncompleted model reasoning processing, a new virtual memory block (for example, a logical block) is allocated to only a newly generated KV token.

After the virtual memory block in the virtual memory address slot is allocated to the newly-added token key-value data of the to-be-processed model reasoning request, in 805, the scheduling apparatus determines, based on the allocated virtual memory block and a capacity size of a currently available physical graphics memory block, whether the to-be-processed model reasoning request is scheduled for execution. The physical graphics memory block can be formed by equally dividing a maximum actually available physical graphics memory capacity of model reasoning.

After the new model reasoning request enters the scheduling apparatus, the scheduling apparatus determines, based on the virtual memory block for occupation, a physical graphics memory capacity that needs to be occupied by a KV token of the virtual memory block, and determines, based on the physical graphics memory capacity that needs to be occupied and a capacity size of a current idle physical graphics memory block, whether a physical graphics memory capacity of the current idle physical graphics memory block is sufficient to be used by the new model reasoning request. If it is determined that the physical graphics memory capacity of the current idle physical graphics memory block is insufficient to be used by the new model reasoning request, the new model reasoning request is not scheduled to be executed in a batch. If it is determined that the physical graphics memory capacity of the current idle physical graphics memory block is insufficient to be used by the new model reasoning request, the scheduling apparatus schedules the new model reasoning request to be executed in a batch, and allocates a proper slot to the new model reasoning request. After the slot is allocated to the new model reasoning request, the scheduling apparatus records slot indication information of the allocated slot in a valid virtual address slot table (slot-mapping). The slot indication information of the slot is used to indicate a specific slot in a valid state (an executed state) in the batch. In some embodiments, the slot indication information of the slot can be a start address, a slot identifier, a slot index, etc. of the allocated slot. FIG. 10 is an example schematic diagram illustrating a valid virtual address slot table, according to one or more embodiments of this specification. In addition, when scheduling the new model reasoning request, the scheduling apparatus further needs to determine whether an idle slot exists in the virtual address space; and if no idle slot exists, the scheduling apparatus does not schedule the new model reasoning request to be executed in the batch.

After the model reasoning request of uncompleted model reasoning processing enters the scheduling apparatus, because a new KV token is generated in a previous forward reasoning process, the generated new KV token needs to be copied to the KV cache. In this case, the scheduling apparatus needs to determine, based on the allocated newly-added virtual memory block and the capacity size of the currently available physical graphics memory block, whether to continue to schedule the model reasoning request to be executed in the batch.

In some embodiments, the scheduling apparatus can determine the slot allocated to the model reasoning request. After the slot is determined, a remaining graphics memory capacity of a physical graphics memory block onto which the slot is mapped is determined. For example, the scheduling apparatus can determine the remaining physical graphics memory capacity of the slot based on an actual size actual_size of the physical graphics memory onto which the slot is mapped and a used size of the physical graphics memory of model reasoning. Then, the scheduling apparatus determines whether the remaining physical graphics memory capacity of the slot is sufficient to store the newly-added token key-value data. If it is determined that the remaining physical graphics memory capacity of the slot is sufficient to store the newly-added token key-value data, the scheduling apparatus determines to continue to schedule the model reasoning request to be executed in the batch.

If it is determined that the remaining physical graphics memory capacity of the slot is insufficient to store the newly-added token key-value data, the scheduling apparatus continues to determine whether the remaining physical graphics memory capacity of the slot and a total available physical graphics memory capacity of the idle physical graphics memory block are sufficient to store the newly-added token key-value data. If it is determined that the remaining physical graphics memory capacity of the slot is sufficient to store the newly-added token key-value data, the scheduling apparatus determines to continue to schedule the model reasoning request to be executed in the batch. If it is determined that the remaining physical graphics memory capacity of the slot is insufficient to store the newly-added token key-value data, the scheduling apparatus determines to not continue to schedule the model reasoning request to be executed in the batch.

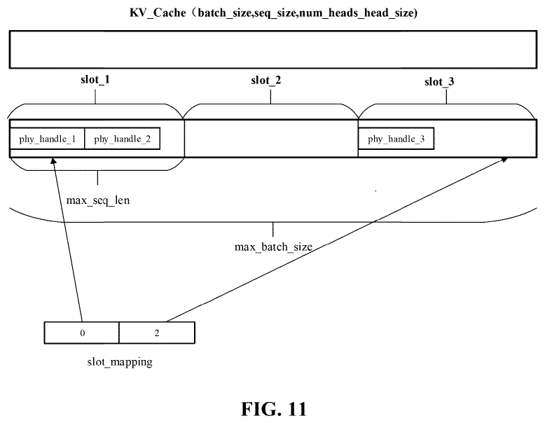

In response to that the to-be-processed model reasoning request is scheduled for execution, in 807, the KV cache management apparatus maintains a mapping relationship between an occupied virtual address slot and an allocated physical graphics memory block. FIG. 11 is a schematic diagram illustrating an example of a KV cache after allocation of a physical graphics memory block is completed and mapping is established, according to one or more embodiments of this specification.

In some embodiments, for a model reasoning request of uncompleted model reasoning processing, when a remaining memory capacity of a currently mapped physical graphics memory block is sufficient to store the newly-added token key-value data, the KV cache management apparatus maintains the mapping relationship of the physical graphics memory block unchanged. In other words, no new physical graphics memory block is additionally mapped. In addition, an actual use capacity of the physical graphics memory block is updated. To be specific, a newly occupied virtual memory capacity is added to the actual use capacity of the physical graphics memory block. When a remaining graphics memory capacity of a currently mapped physical graphics memory block is insufficient to store the newly-added token key-value data, the KV cache management apparatus additionally maps a sufficient quantity of physical graphics memory blocks in idle physical graphics memory blocks to the occupied virtual address slot, and updates an actual mapping capacity actual_size of the physical graphics memory block. After the actual mapping capacity actual_size is updated, the new KV token is copied to the physical graphics memory block, and the actual use capacity used_size is updated, to complete dynamic updating of the physical graphics memory.

In some specific embodiments, when the scheduling result indicates that the to-be-processed model reasoning request is scheduled for execution, for a new model reasoning request, the KV cache management apparatus maps a sufficient quantity of physical graphics memory blocks in idle physical graphics memory blocks to the occupied virtual address slot, and updates an actual mapping quantity and an actual use capacity of the physical graphics memory block.

After the mapping is completed, in 808, a data copying apparatus copies the newly-added token key-value data of the to-be-processed model reasoning request to the physical graphics memory block allocated to the to-be-processed model reasoning request.

After preparation for the model reasoning process is completed as described above, in response to that the model reasoning process is executed, in 809, a model reasoning apparatus performs model reasoning processing.

Specifically, the model reasoning apparatus determines a physical graphics memory block corresponding to the to-be-processed model reasoning request based on the slot indication information of the virtual address slot in the valid virtual address slot table. For example, the model reasoning apparatus determines, based on the slot indication information of the virtual address slot in the valid virtual address slot table, a start address of the physical graphics memory block corresponding to the to-be-processed model reasoning request. In some embodiments, the model reasoning apparatus can determine, according to the interval index of the virtual address slot in the valid virtual address slot table, the start address of the physical graphics memory block corresponding to the to-be-processed model reasoning request. Then, the model reasoning apparatus sequentially retrieves all stored sequence token key-value data from the determined physical graphics memory block, and then, performs model reasoning based on the retrieved sequence token key-value data.

In some embodiments, the start address of the physical graphics memory block corresponding to the to-be-processed model reasoning request can be retrieved based on the virtual address slot in the valid virtual address slot table by merely modifying an addressing instruction of an attention framework for performing model reasoning, so that a model reasoning engine is modified to a relatively small extent.

It is worthwhile to note that when the to-be-processed model reasoning request includes the new model reasoning request and the model reasoning request of uncompleted model reasoning, scheduling processing of the model reasoning request of uncompleted model reasoning processing is completed before scheduling processing of the new model reasoning request. In such a processing manner, when the physical graphics memory block is insufficient to support to simultaneous schedule, for execution, the new model reasoning request and the model reasoning request of uncompleted model reasoning, it is ensured to continue to schedule the model reasoning request of uncompleted model reasoning, to improve model reasoning efficiency.

In some embodiments, when the physical graphics memory block is insufficient to support to schedule, for execution, the model reasoning request of uncompleted model reasoning, a virtual address slot and a virtual memory block that are occupied by the model reasoning request of uncompleted model reasoning can be further released, and the mapping relationship between the occupied virtual address slot and the allocated physical graphics memory block is removed. The virtual memory block and the physical graphics memory block that are released can be used for scheduling processing of the new model reasoning request.

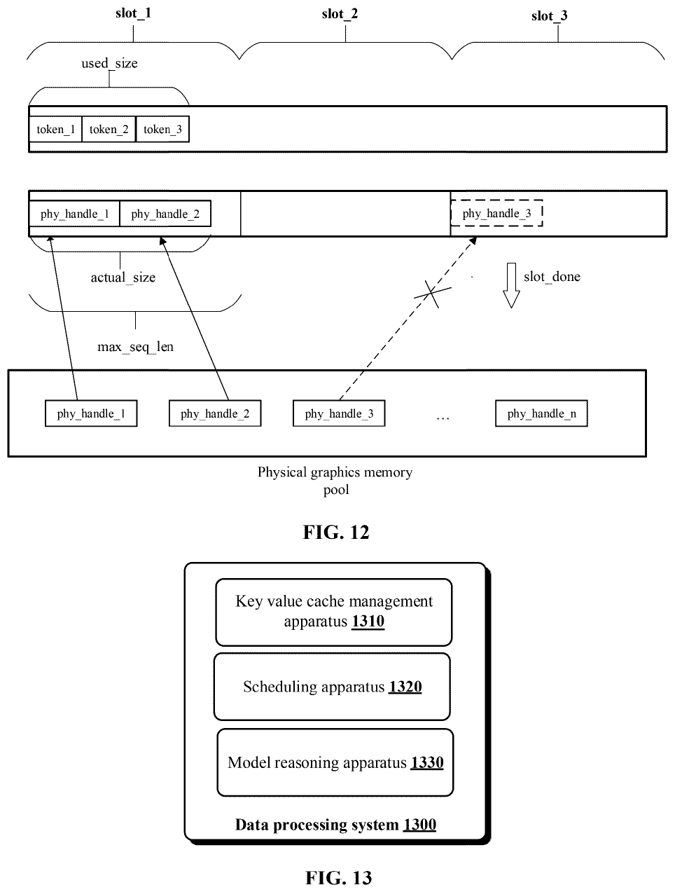

It is worthwhile to note that for a model reasoning request processed in the previous forward reasoning process, if model reasoning is completed to obtain a final output sequence, the occupied virtual address slot (for example, a virtual memory block logical block) needs to be released, a mapping relationship between an allocated physical handle and the occupied virtual address slot is removed, and slot information corresponding to the reasoning request is returned to the scheduler. Subsequently, the scheduler deletes the slot from the valid virtual address slot table. FIG. 12 is an example schematic diagram illustrating a KV cache management solution for a completed model reasoning request, according to one or more embodiments of this specification.

In some embodiments, KV cache management for the completed model reasoning request can be performed before the to-be-processed model reasoning request is scheduled, so that the virtual memory block and the physical graphics memory block that are released can be used for scheduling processing of the model reasoning request.

FIG. 13 is an example block diagram illustrating a data processing system 1300 for large language model reasoning, according to one or more embodiments of this specification. As shown in FIG. 13, the data processing system 1300 includes a key-value cache management apparatus 1310, a scheduling apparatus 1320, and a model reasoning apparatus 1330.

The key-value cache management apparatus 1310 is configured to perform key-value cache management during large language model reasoning.

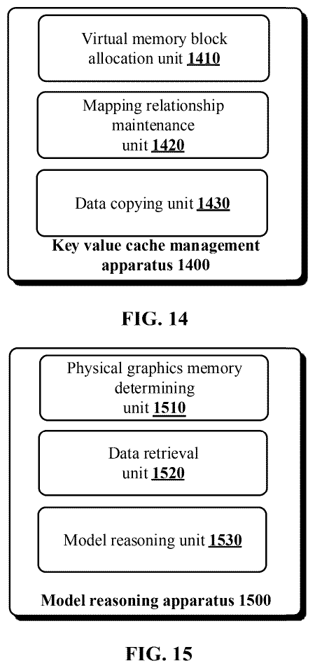

FIG. 14 is an example block diagram illustrating a key-value cache management apparatus 1400 for large language model reasoning, according to one or more embodiments of this specification. As shown in FIG. 14, the key-value cache management apparatus 1400 includes a virtual memory block allocation unit 1410, a mapping relationship maintenance unit 1420, and a data copying unit 1430.

The virtual memory block allocation unit 1410 is configured to allocate a virtual memory block in a virtual address slot to newly-added token key-value data of a to-be-processed model reasoning request. The virtual address slot is formed by equally dividing a virtual address space needed by a key-value cache, and a quantity of virtual address slots is equal to a maximum amount of batch request processing of a large language model.

The mapping relationship maintenance unit 1420 is configured to: after it is determined, based on the allocated virtual memory block and a capacity size of a currently available physical graphics memory block, that the to-be-processed model reasoning request is scheduled for execution, maintain a mapping relationship between an occupied virtual address slot and a physical graphics memory block allocated to the to-be-processed model reasoning request. The physical graphics memory block is formed by equally dividing a maximum actually available physical graphics memory capacity of model reasoning. Each to-be-processed model reasoning request scheduled for execution occupies one virtual address slot, and an occupied virtual address slot is recorded in a valid virtual address slot table.

The data copying unit 1430 is configured to copy the newly-added token key-value data of the to-be-processed model reasoning request to the allocated physical graphics memory block.

In addition, the key-value cache management apparatus 1310 can further include an initialization unit (not shown), configured to implement initialization processing of virtual memory and physical graphics memory.

During initialization, in the case of a given model and running hardware information, the initialization unit determines a maximum amount of graphics memory available to a KV cache in a model reasoning framework in a case of a current configuration. Subsequently, the initialization unit invokes the scheduling apparatus 1320 to allocate a plurality of physical handles at a granularity of a specified capacity size (for example, 2 MB), a total capacity size of the plurality of physical handles is equal to the maximum amount of physical graphics memory, and the plurality of physical handles are placed in a physical graphics memory pool. Then, the initialization unit invokes the scheduling apparatus 1320 to allocate, based on a configuration of the model reasoning framework, a virtual address space needed by the KV cache.

The scheduling apparatus 1320 determines, based on the allocated virtual memory block and the capacity size of the currently available physical graphics memory block, whether the to-be-processed model reasoning request is scheduled for execution. Each to-be-processed model reasoning request scheduled for execution occupies one virtual address slot, and slot indication information of the virtual address slot occupied by the to-be-processed model reasoning request is recorded in a valid virtual address slot table.

The model reasoning apparatus 1330 is configured to: obtain token key-value data needed for model reasoning, and perform model reasoning based on the obtained token key-value data.

FIG. 15 is an example block diagram illustrating a model reasoning apparatus 1500 for large language model reasoning, according to one or more embodiments of this specification. As shown in FIG. 15, the model reasoning apparatus 1500 includes a physical graphics memory block determining unit 1510, a data retrieval unit 1520, and a model reasoning unit 1530.

The physical graphics memory block determining unit 1510 is configured to: in response to that execution of a model reasoning request is started, determine a physical graphics memory block corresponding to performed model reasoning based on slot indication information of a virtual address slot in a valid virtual address slot table. Subsequently, the data retrieval unit 1520 sequentially retrieves all stored sequence token key-value data from the determined physical graphics memory block, and then, the model reasoning unit 1530 performs model reasoning based on the retrieved sequence token key-value data.

The key-value cache management method, the model reasoning method, the data processing method, the key-value cache management apparatus, the model reasoning apparatus, and the data processing system that are for large language model reasoning according to the embodiments of this specification are described with reference to FIG. 1 to FIG. 15. The key-value cache management apparatus, the model reasoning apparatus, and the data processing system can be implemented by using hardware, or can be implemented by using software or a combination of hardware and software.

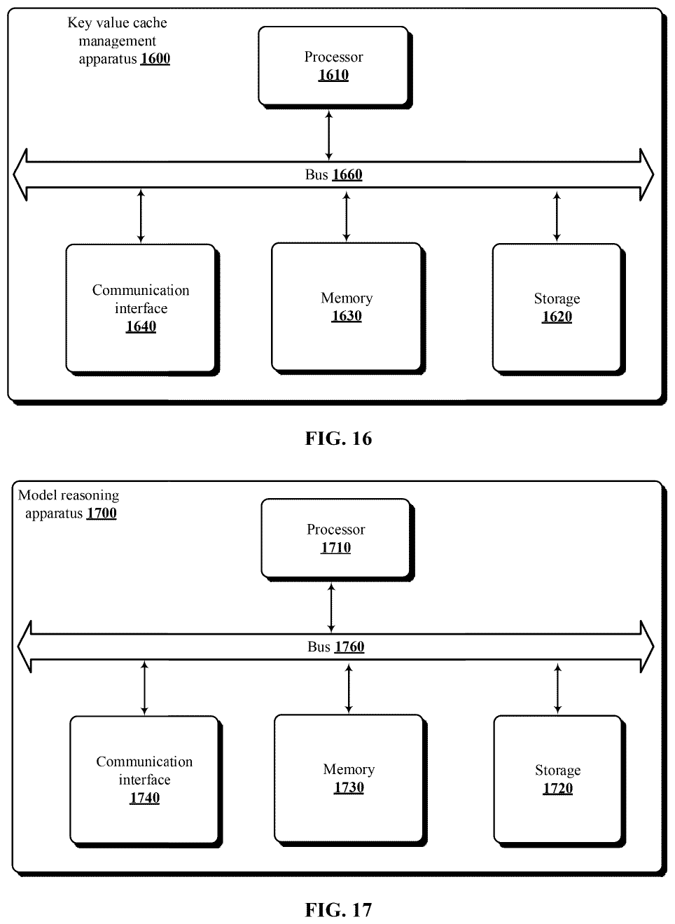

FIG. 16 is an example schematic diagram illustrating a key-value cache management apparatus 1600 for large language model reasoning that is implemented based on a computer system, according to one or more embodiments of this specification. As shown in FIG. 16, the key-value cache management apparatus 1600 can include at least one processor 1610, a storage (for example, a nonvolatile memory) 1620, a memory 1630, and a communication interface 1640, and the at least one processor 1610, the storage 1620, the memory 1630, and the communication interface 1640 are connected together through a bus 1660. The at least one processor 1610 executes at least one computer-readable instruction (namely, the above-mentioned elements implemented in a software form) stored or encoded in the storage.

In one or more embodiments, the storage stores computer-executable instructions, and when the computer-executable instructions are executed, the at least one processor 1610 is configured to: allocate a virtual memory block in a virtual address slot to newly-added token key-value data of a to-be-processed model reasoning request, where the virtual address slot is formed by equally dividing a virtual address space needed by a key-value cache, and a quantity of virtual address slots is equal to a maximum amount of batch request processing of a large language model; maintain a mapping relationship between an occupied virtual address slot and a physical graphics memory block allocated to the to-be-processed model reasoning request, in response to that a scheduling result of the to-be-processed model reasoning request indicates that the to-be-processed model reasoning request is scheduled for execution, where the physical graphics memory block is formed by equally dividing a maximum actually available physical graphics memory capacity of model reasoning; and copy the newly-added token key-value data to the allocated physical graphics memory block, where the scheduling result is determined based on the allocated virtual memory block and a capacity size of a currently available physical graphics memory block, each to-be-processed model reasoning request occupies one virtual address slot, and slot indication information of the occupied virtual address slot is recorded in a valid virtual address slot table.

It should be understood that, when the computer-executable instructions stored in the storage are executed, the at least one processor 1610 is enabled to perform the above-mentioned operations and functions described with reference to FIG. 8 to FIG. 15 in the embodiments of this specification.

FIG. 17 is an example schematic diagram illustrating a model reasoning apparatus 1700 for large language model reasoning that is implemented based on a computer system, according to one or more embodiments of this specification. As shown in FIG. 17, the model reasoning apparatus 1700 can include at least one processor 1710, a storage (for example, a nonvolatile memory) 1720, a memory 1730, and a communication interface 1740, and the at least one processor 1710, the storage 1720, the memory 1730, and the communication interface 1740 are connected together through a bus 1760. The at least one processor 1710 executes at least one computer-readable instruction (namely, the above-mentioned elements implemented in a software form) stored or encoded in the storage.

In one or more embodiments, the storage stores computer-executable instructions, and when the computer-executable instructions are executed, the at least one processor 1710 is enabled to perform the following operations: in response to that performing of model reasoning is started, determining a physical graphics memory block corresponding to performed model reasoning based on slot indication information of a virtual address slot in a valid virtual address slot table; sequentially retrieving all stored sequence token key-value data from the determined physical graphics memory block; and performing model reasoning based on the sequence token key-value data.

It should be understood that, when the computer-executable instructions stored in the storage are executed, the at least one processor 1710 is enabled to perform the above-mentioned operations and functions described with reference to FIG. 8 to FIG. 15 in the embodiments of this specification.

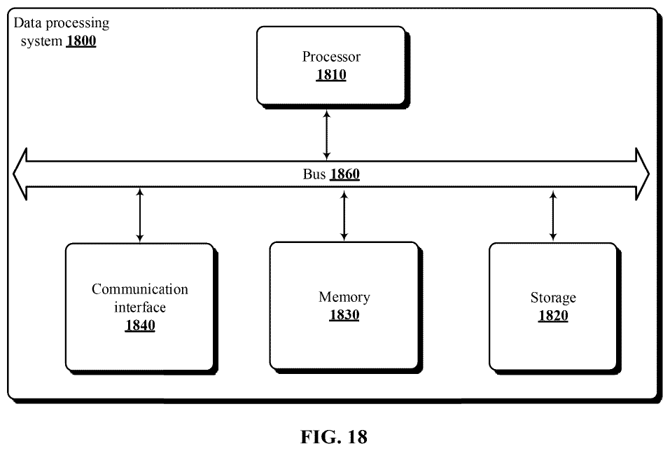

FIG. 18 is an example schematic diagram illustrating a data processing system 1800 for large language model reasoning that is implemented based on a computer system, according to one or more embodiments of this specification. As shown in FIG. 18, the data processing system 1800 can include at least one processor 1810, a storage (for example, a nonvolatile memory) 1820, a memory 1830, and a communication interface 1840, and the at least one processor 1810, the storage 1820, the memory 1830, and the communication interface 1840 are connected together through a bus 1860. The at least one processor 1810 executes at least one computer-readable instruction (namely, the above-mentioned elements implemented in a software form) stored or encoded in the storage.

In one or more embodiments, the storage stores computer-executable instructions, and when the computer-executable instructions are executed, at least one processor 1810 is enabled to perform the following operations: allocating a virtual memory block in a virtual address slot to newly-added token key-value data of a to-be-processed model reasoning request, where the virtual address slot is formed by equally dividing a virtual address space needed by a key-value cache, and a quantity of virtual address slots is equal to a maximum amount of batch request processing of a large language model; determining, based on the allocated virtual memory block and a physical graphics memory capacity of a currently available physical graphics memory block, whether the to-be-processed model reasoning request is scheduled for execution, where the physical graphics memory block is formed by equally dividing a maximum actually available physical graphics memory capacity of model reasoning, each to-be-processed model reasoning request occupies one virtual address slot, and slot indication information of the occupied virtual address slot is recorded in a valid virtual address slot table; maintaining a mapping relationship between the occupied virtual address slot and a physical graphics memory block allocated to the to-be-processed model reasoning request, in response to that the to-be-processed model reasoning request is scheduled for execution; copying the newly-added token key-value data to the allocated physical graphics memory block; in response to that performing of model reasoning is started, determining the physical graphics memory block corresponding to the to-be-processed model reasoning request based on slot indication information of the virtual address slot in the valid virtual address slot table, and sequentially retrieving all stored sequence token key-value data from the determined physical graphics memory block; and performing model reasoning based on the sequence token key-value data.

It should be understood that, when the computer-executable instructions stored in the storage are executed, the at least one processor 1810 is enabled to perform the above-mentioned operations and functions described with reference to FIG. 8 to FIG. 15 in the embodiments of this specification.

According to one or more embodiments, a program product such as a machine-readable medium (for example, a non-transitory machine-readable medium) is provided. The machine-readable medium can have instructions (to be specific, the above-mentioned element implemented in a software form). When the instruction is executed by a machine, the machine is enabled to perform the above-mentioned operations and functions described with reference to FIG. 1 to FIG. 15 in the embodiments of this specification. Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instructions stored in the readable storage medium.

In such a case, the program code read from the readable medium can implement the functions in any one of some embodiments described above, and therefore the machine-readable code and the readable storage medium storing the machine-readable code form a part of this application.

Embodiments of the readable storage medium include a floppy disk, a hard disk, a magneto-optical disk, an optical disc (for example, a CD-ROM, a CD-R, a CD-RW, a DVD-ROM, a DVD-RAM, and a DVD-RW), a magnetic tape, a nonvolatile memory card, and a ROM. Alternatively, the program code can be downloaded from a server computer or a cloud by a communication network.

According to one or more embodiments, a computer program product is provided. The computer program product includes a computer program, and when the computer program is executed by a processor, the processor is enabled to perform the above-mentioned operations and functions described with reference to FIG. 1 to FIG. 15 in the embodiments of this specification.

A person skilled in the art should understand that various variations and modifications can be made to embodiments disclosed above without departing from the essence of this specification. Therefore, the protection scope of this specification should be defined by the appended claims.

It is worthwhile to note that, not all the steps and units in the above-mentioned processes and system structure diagrams are necessary, and some steps or units can be ignored based on an actual need. An order of performing the steps is not fixed, and can be determined based on a need. The apparatus structure described in the above-mentioned embodiments can be a physical structure or a logical structure. In other words, some units can be implemented by the same physical entity, or some units can be implemented by a plurality of physical entities, or can be implemented together by some components in a plurality of independent devices.

In the above-mentioned embodiments, a hardware unit or module can be implemented mechanically or electrically. For example, a hardware unit, a module, or a processor can include a permanent dedicated circuit or logic (such as a dedicated processor, FPGA, or ASIC) to complete a corresponding operation. The hardware unit or the processor can further include a programmable logic or circuit (for example, a general-purpose processor or another programmable processor), and can be set temporarily by software to complete a corresponding operation. Specific implementations (mechanical methods, dedicated permanent circuits, or temporarily disposed circuits) can be determined based on cost and time considerations.

The specific implementations illustrated above with reference to the accompanying drawings describe example embodiments, but do not represent all embodiments that can be implemented or fall within the protection scope of the claims. The term “example” used throughout this specification means “used as an example, an instance, or an illustration”, but does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

The foregoing descriptions of the present disclosure are provided to enable any person of ordinary skill in the art to implement or use the present disclosure. Various modifications made to the present disclosure are apparent to a person of ordinary skill in the art, and the general principles defined in this specification can also be applied to other variants without departing from the protection scope of the present disclosure. Therefore, the present disclosure is not limited to the examples and designs described in this specification, but corresponds to the widest scope of principles and novel features disclosed in this specification.

1. A method of key-value cache management, comprising:
allocating a virtual memory block in a virtual address slot to newly-added token key-value data of a model reasoning request, wherein the virtual address slot is formed by equally dividing a virtual address space of a key-value cache, and a quantity of virtual address slots is equal to a maximum amount of batch request processing of a large language model;
in response to determining that a scheduling result of the model reasoning request indicates the model reasoning request is scheduled for execution, maintaining a mapping relationship between an occupied virtual address slot and a physical graphics memory block allocated to the model reasoning request, wherein the physical graphics memory block is formed by equally dividing a maximum available physical graphics memory capacity of model reasoning; and
copying the newly-added token key-value data to the physical graphics memory block, wherein the scheduling result is determined based on the allocated virtual memory block and a capacity of an available physical graphics memory block, each model reasoning request occupies a virtual address slot, and slot indication information of the occupied virtual address slot is recorded in a valid virtual address slot table.

2. The method according to claim 1, wherein before allocating the virtual memory block and after a previous model reasoning process, the method further comprises:
for a model reasoning request of completed model reasoning processing, releasing an occupied virtual address slot, terminating the mapping relationship between the physical graphics memory block and the occupied virtual address slot, and deleting the slot indication information of the occupied virtual address slot from the valid virtual address slot table.

3. The method according to claim 2, wherein the model reasoning request comprises a new model reasoning request and a model reasoning request of uncompleted model reasoning processing after the previous model reasoning process, and scheduling processing of the model reasoning request of uncompleted model reasoning processing is completed before scheduling processing of the new model reasoning request.

4. The method according to claim 1, wherein maintaining the mapping relationship comprises:
for a model reasoning request of uncompleted model reasoning processing:
when a remaining graphics memory capacity of a currently mapped physical graphics memory block is sufficient to store the newly-added token key-value data, keeping the mapping relationship of the physical graphics memory block unchanged, and updating a use capacity of the physical graphics memory block; or
when a remaining graphics memory capacity of a currently mapped physical graphics memory block is insufficient to store the newly-added token key-value data, mapping a sufficient quantity of physical graphics memory blocks in idle physical graphics memory blocks to the occupied virtual address slot, and updating a mapping quantity and a use capacity of physical graphics memory blocks.

5. The method according to claim 1, wherein maintaining the mapping relationship comprises:
for a new model reasoning request, mapping a sufficient quantity of physical graphics memory blocks in idle physical graphics memory blocks to the occupied virtual address slot, and updating a mapping quantity and a use capacity of the physical graphics memory block.

6. The method according to claim 1, wherein the virtual address space is determined based on a maximum quantity of batch processing requests of the large language model, a maximum sequence length, a quantity of hidden layers of the large language model, and a data type size of stored data.

7. An apparatus comprising:
at least one processor; and
one or more memories coupled to the at least one processor and storing programming instructions for execution by the at least one processor to perform operations comprising:
allocating a virtual memory block in a virtual address slot to newly-added token key-value data of a model reasoning request, wherein the virtual address slot is formed by equally dividing a virtual address space of a key-value cache, and a quantity of virtual address slots is equal to a maximum amount of batch request processing of a large language model;
in response to determining that a scheduling result of the model reasoning request indicates the model reasoning request is scheduled for execution, maintaining a mapping relationship between an occupied virtual address slot and a physical graphics memory block allocated to the model reasoning request, wherein the physical graphics memory block is formed by equally dividing a maximum available physical graphics memory capacity of model reasoning; and
copying the newly-added token key-value data to the physical graphics memory block, wherein the scheduling result is determined based on the allocated virtual memory block and a capacity of an available physical graphics memory block, each model reasoning request occupies a virtual address slot, and slot indication information of the occupied virtual address slot is recorded in a valid virtual address slot table.

8. The apparatus according to claim 7, wherein before allocating the virtual memory block and after a previous model reasoning process, the operations further comprise:
for a model reasoning request of completed model reasoning processing, releasing an occupied virtual address slot, terminating the mapping relationship between the physical graphics memory block and the occupied virtual address slot, and deleting the slot indication information of the occupied virtual address slot from the valid virtual address slot table.

9. The apparatus according to claim 8, wherein the model reasoning request comprises a new model reasoning request and a model reasoning request of uncompleted model reasoning processing after the previous model reasoning process, and scheduling processing of the model reasoning request of uncompleted model reasoning processing is completed before scheduling processing of the new model reasoning request.

10. The apparatus according to claim 7, wherein maintaining the mapping relationship comprises:
for a model reasoning request of uncompleted model reasoning processing:
when a remaining graphics memory capacity of a currently mapped physical graphics memory block is sufficient to store the newly-added token key-value data, keeping the mapping relationship of the physical graphics memory block unchanged, and updating a use capacity of the physical graphics memory block; or
when a remaining graphics memory capacity of a currently mapped physical graphics memory block is insufficient to store the newly-added token key-value data, mapping a sufficient quantity of physical graphics memory blocks in idle physical graphics memory blocks to the occupied virtual address slot, and updating a mapping quantity and a use capacity of physical graphics memory blocks.

11. The apparatus according to claim 7, wherein maintaining the mapping relationship comprises:
for a new model reasoning request, mapping a sufficient quantity of physical graphics memory blocks in idle physical graphics memory blocks to the occupied virtual address slot, and updating a mapping quantity and a use capacity of the physical graphics memory block.

12. The apparatus according to claim 7, wherein the virtual address space is determined based on a maximum quantity of batch processing requests of the large language model, a maximum sequence length, a quantity of hidden layers of the large language model, and a data type size of stored data.

13. A non-transitory, computer-readable medium storing one or more instructions executable by at least one processor to perform operations comprising:
allocating a virtual memory block in a virtual address slot to newly-added token key-value data of a model reasoning request, wherein the virtual address slot is formed by equally dividing a virtual address space of a key-value cache, and a quantity of virtual address slots is equal to a maximum amount of batch request processing of a large language model;
in response to determining that a scheduling result of the model reasoning request indicates the model reasoning request is scheduled for execution, maintaining a mapping relationship between an occupied virtual address slot and a physical graphics memory block allocated to the model reasoning request, wherein the physical graphics memory block is formed by equally dividing a maximum available physical graphics memory capacity of model reasoning; and
copying the newly-added token key-value data to the physical graphics memory block, wherein the scheduling result is determined based on the allocated virtual memory block and a capacity of an available physical graphics memory block, each model reasoning request occupies a virtual address slot, and slot indication information of the occupied virtual address slot is recorded in a valid virtual address slot table.

14. The non-transitory, computer-readable medium according to claim 13, wherein before allocating the virtual memory block and after a previous model reasoning process, the operations further comprise:
for a model reasoning request of completed model reasoning processing, releasing an occupied virtual address slot, terminating the mapping relationship between the physical graphics memory block and the occupied virtual address slot, and deleting the slot indication information of the occupied virtual address slot from the valid virtual address slot table.

15. The non-transitory, computer-readable medium according to claim 14, wherein the model reasoning request comprises a new model reasoning request and a model reasoning request of uncompleted model reasoning processing after the previous model reasoning process, and scheduling processing of the model reasoning request of uncompleted model reasoning processing is completed before scheduling processing of the new model reasoning request.

16. The non-transitory, computer-readable medium according to claim 13, wherein maintaining the mapping relationship comprises:
for a model reasoning request of uncompleted model reasoning processing:
when a remaining graphics memory capacity of a currently mapped physical graphics memory block is sufficient to store the newly-added token key-value data, keeping the mapping relationship of the physical graphics memory block unchanged, and updating a use capacity of the physical graphics memory block; or
when a remaining graphics memory capacity of a currently mapped physical graphics memory block is insufficient to store the newly-added token key-value data, mapping a sufficient quantity of physical graphics memory blocks in idle physical graphics memory blocks to the occupied virtual address slot, and updating a mapping quantity and a use capacity of physical graphics memory blocks.

17. The non-transitory, computer-readable medium according to claim 13, wherein maintaining the mapping relationship comprises:
for a new model reasoning request, mapping a sufficient quantity of physical graphics memory blocks in idle physical graphics memory blocks to the occupied virtual address slot, and updating a mapping quantity and a use capacity of the physical graphics memory block.

18. The non-transitory, computer-readable medium according to claim 13, wherein the virtual address space is determined based on a maximum quantity of batch processing requests of the large language model, a maximum sequence length, a quantity of hidden layers of the large language model, and a data type size of stored data.
